(19) United States
(12) Patent Application Publication
(10) Pub. No.: US 2026/0188293 A1
(43) Pub. Date: Jul. 2, 2026

(54) AUDIO PROCESSING METHOD AND ELECTRONIC DEVICE

(71) Applicant: Lenovo (Beijing) Limited, Beijing (CN)

(72) Inventors: Hongzhou HUANG, Beijing (CN); Rongbin XIAO, Beijing (CN)

(21) Appl. No.: 19/432,230

(22) Filed: Dec. 24, 2025

(30) Foreign Application Priority Data
Dec. 31, 2024 (CN) 202411998983.2

(51) Int. Cl. G10K 11/178

(52) U.S. Cl. CPC G10K 11/17821

(57) ABSTRACT

A method of audio processing includes obtaining audio data, identifying, based on a target model and from the audio data, a first type of noise and a second type of noise that are of different types, and outputting a first interaction element corresponding to the first type of noise and a second interaction element corresponding to the second type of noise. The first interaction element is configured to configure noise cancellation for the first type of noise, and the second interaction element is configured to configure noise cancellation for the second type of noise.

### CROSS-REFERENCE TO RELATED APPLICATION

This application claims priority to Chinese Patent Application No. 202411998983.2, filed on Dec. 31, 2024, the entire content of which is incorporated herein by reference.

### TECHNICAL FIELD

The present disclosure generally relates to the noise cancellation technology field and, more particularly, to an audio processing method and an electronic device.

### BACKGROUND

In the process of acquiring video or audio, the electronic device can perform noise cancellation treatment on the obtained audio data, but the overall noise cancellation effect is not ideal, and there is still more room to improve.

### SUMMARY

In accordance with the disclosure, there is provided a method of audio processing including obtaining audio data, identifying, based on a target model and from the audio data, a first type of noise and a second type of noise that are of different types, and outputting a first interaction element corresponding to the first type of noise and a second interaction element corresponding to the second type of noise. The first interaction element is configured to configure noise cancellation for the first type of noise, and the second interaction element is configured to configure noise cancellation for the second type of noise.

Also in accordance with the disclosure, there is provided an electronic device including a processor, and a memory storing instructions that, when executed by the processor, cause the electronic device to obtain audio data, identify, based on a target model and from the audio data, a first type of noise and a second type of noise that are of different types, and output a first interaction element corresponding to the first type of noise and a second interaction element corresponding to the second type of noise. The first interaction element is configured to configure noise cancellation for the first type of noise, and the second interaction element is configured to configure noise cancellation for the second type of noise.

Also in accordance with the disclosure, there is provided a method of audio processing including obtaining first audio data, and determining a target noise cancellation model based on a target object representing an audio scene in which the first audio data is obtained. The target noise cancellation model has a plurality of sets of noise cancellation configurations, and the plurality of sets of noise cancellation configurations include at least one set of configurations obtained based on an interaction method provided to the user. The method further includes determining a target noise cancellation configuration belonging to one set of the plurality of sets of noise cancellation configurations, and performing, using the target noise cancellation model, noise cancellation processing on the first audio data based on the target noise cancellation configuration to generate second audio data.

### BRIEF DESCRIPTION OF THE DRAWINGS

In order to more clearly illustrate the technical solutions in the embodiments of the present disclosure, the drawings for the description of the embodiments will be briefly introduced below. Obviously, the drawings in the following description are only some embodiments of the present disclosure. For a person of ordinary skill in the art, other drawings can also be obtained according to the provided drawings without creative efforts.

FIG. 1 is a flowchart of an audio processing method consistent with the present disclosure.

FIG. 2 is an exemplary diagram showing a display interface of an interaction element consistent with the present disclosure.

FIG. 3 is an exemplary diagram showing a display interface of another interaction element consistent with the present disclosure.

FIG. 4 is a flowchart of another audio processing method consistent with the present disclosure.

FIG. 5 is a flowchart of another audio processing method consistent with the present disclosure.

FIG. 6 is a schematic structural diagram of an electronic device consistent with the present disclosure.

FIG. 7 is a schematic structural diagram of another electronic device consistent with the present disclosure.

### DETAILED DESCRIPTION OF THE EMBODIMENTS

The technical solutions of the embodiments of the present disclosure will be described below with reference to the accompanying drawings. Obviously, the embodiments described are only some of the embodiments of the present disclosure, and not all of them. Based on the described embodiments, all other embodiments obtained by those skilled in the art without creative effort are within the scope of the present disclosure.

The embodiments of the present disclosure can be applied to electronic devices. The present disclosure does not limit the product form of the electronic device, which may include but is not limited to smartphones, tablets, wearable devices, personal computers (PCs), netbooks, etc., and can be selected according to actual needs.

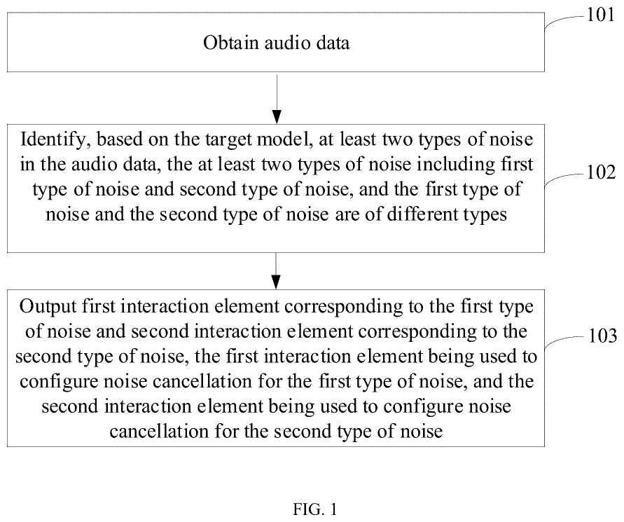

FIG. 1 is a flowchart of an audio processing method consistent with the present disclosure. As shown in FIG. 1, the audio processing method includes the following.

At 101, audio data is obtained.

The audio data can be audio data in video content or standalone audio data. Consistent with the present disclosure, the audio data refers to audio data that already exists or is stored in the electronic device, and the audio data may have already undergone noise cancellation processing using a corresponding noise cancellation model during the acquisition process. The noise cancellation model is a general-purpose noise cancellation model that does not differentiate between audio data acquired in different audio acquisition scenes.

The audio data includes processed audio data processed by the aforementioned general-purpose noise cancellation model, or includes both the processed audio data and original, unprocessed audio data, or includes the processed audio data and corresponding processing parameters.

At 102, based on the target model, at least two types of noise are identified in the audio data. The at least two types of noise includes first type of noise and second type of noise, and the first type of noise and the second type of noise are of different types.

The target model can be a pre-trained model capable of recognizing various types of noise in audio data. A noise type may correspond to only one sound source, or it may correspond to multiple sound sources. For example, in a natural environment, sound of wind is identified as a single sound source and classified as a type of noise—wind noise; in an outdoor setting, the sounds of multiple sound sources, such as car horns, conversations among pedestrians on the street, and vendors'calls, are categorized as one type of noise—background noise. Furthermore, other types of noise can include, for example, harmful noises including harsh sounds like chainsaws and construction hammering, and concert noises including applause and conversations from the audience.

The number of noise types contained in the audio data is not fixed and can be any sound type other than the main tone in the audio data identified by the target model. Theoretically, the number of noise types in the audio data identified by the target model can be any number, including one type. However, in the present disclosure, the noise types identified by the target model are set to at least two types to demonstrate that noise cancellation can be configured individually for different types of noise.

Since the aforementioned processed audio data is audio data processed by a general-purpose noise cancellation model, some noise may have been suppressed to the point of being difficult to accurately identify. Therefore, consistent with the present disclosure, audio data identified by the target model can be the original audio data, ensuring that all types of noise contained in the audio data can be identified.

At 103, first interaction element corresponding to the first type of noise and second interaction element corresponding to the second type of noise are output. The first interaction element is used to configure noise cancellation for the first type of noise, and the second interaction element is used to configure noise cancellation for the second type of noise.

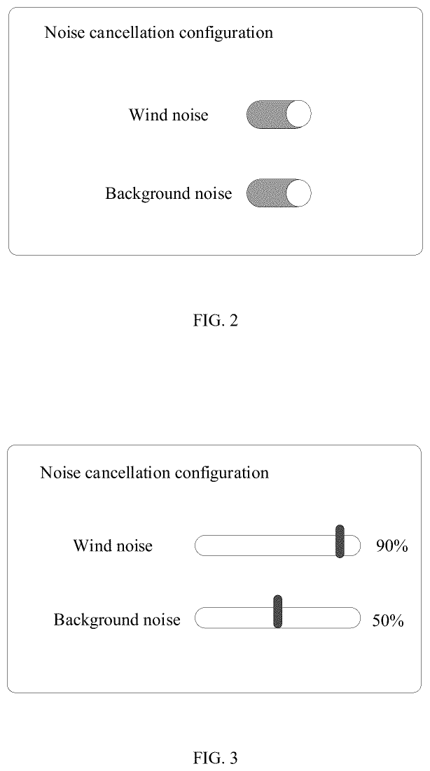

After the at least two types of noise are identified, a corresponding interaction element can be output for each type of noise. Each interaction element is used to configure individual noise cancellation configuration for a specific type of noise. The configuration includes, but is not limited to, configuring whether noise cancellation is enabled for the current type of noise. FIG. 2 is an example of the display interface of an interaction element disclosed in the present disclosure, in which, noise cancellation is enabled for wind noise and background noise by default.

The interaction elements consistent with the present disclosure are not limited to virtual objects that can be directly controlled or triggered with an input device by the user in a human-computer interaction interface, and the interaction elements can generally refer to anything that can provide a basis for user interaction, enabling users to configure noise cancellation for corresponding types of noise. For example, outputting the first interaction element corresponding to the first type of noise and the second interaction element corresponding to the second type of noise can simply be outputting an item list of various noise types on the screen. These items are not operable; they are only used to show which types of noise are included in the audio data. Users can input which type of noise they want to reduce noise through voice commands.

The method consistent with the present disclosure can be a post-editing process for audio files generated from video recordings or audio recordings. This method provides users with an interactive method that allows users to independently configure noise cancellation for different types of noise in the audio data based on their own needs or preferences, thereby ultimately obtaining audio that meets the user's expectations.

The audio processing method consistent with the present disclosure first identifies at least two types of noise in the audio data, then outputs a corresponding interaction element for each type of noise, allowing users to independently configure noise cancellation for each type of noise, thus meeting their needs for personalized noise cancellation processing of audio data.

In the above embodiment, the first interaction element used to configure noise cancellation for the first type of noise can include the degree of noise cancellation processing for the first type of noise; the second interaction element used to configure noise cancellation for the second type of noise can include the degree of noise cancellation processing for the second type of noise.

That is, the noise cancellation configuration for each type of noise can not only configure whether noise cancellation is enabled for a certain type of noise, but also further configure the degree of noise cancellation or noise cancellation parameters for the noise types for which noise cancellation is enabled. For example, a user can use the first interaction element to configure noise cancellation for the first type of noise to be reducing noise by 50% and use the second interaction element to configure noise cancellation for the second type of noise to be reducing noise by 30%. This configuration allows users more freedom in configuring noise cancellation for various types of noise. FIG. 3 is an example of the display interface of another interaction element consistent with the present disclosure, taking wind noise cancellation ratio of 90% (i.e., wind noise being reduced by 90%) and background noise cancellation ratio of 50% (i.e., background noise being reduced by 50%) as an example.

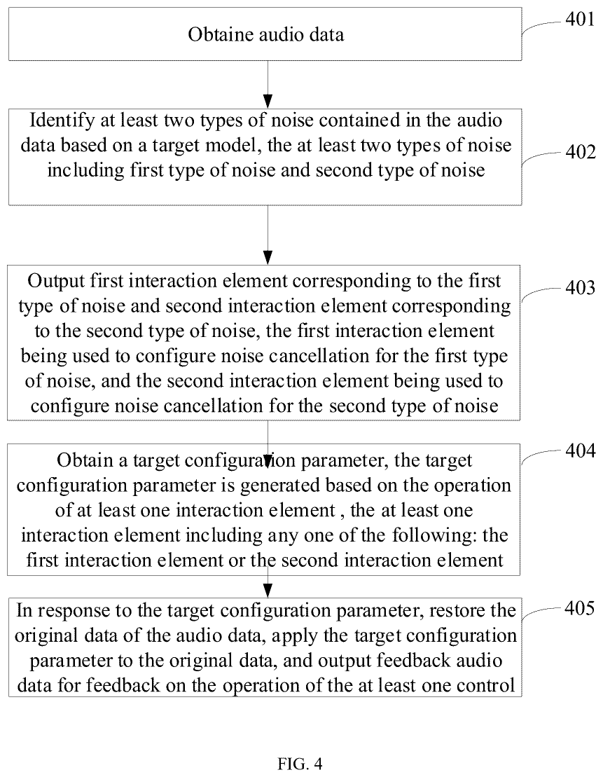

FIG. 4 is a flowchart of another audio processing method consistent with the present disclosure. Based on the foregoing content, the audio processing method includes the following.

At 401, audio data is obtained.

At 402, at least two types of noise contained in the audio data are identified based on a target model. The at least two types of noise include first type of noise and second type of noise, and the first type of noise and the second type of noise are of different types.

At 403, first interaction element corresponding to the first type of noise and second interaction element corresponding to the second type of noise are output. The first interaction element is used to configure noise cancellation for the first type of noise; the second interaction element is used to configure noise cancellation for the second type of noise.

At 404, a target configuration parameter is obtained, the target configuration parameter being generated based on the operation of at least one interaction element, the at least one interaction element including any one of the following: the first interaction element or the second interaction element.

Consistent with the present disclosure, for the first interaction element and the second interaction element, the user can individually operate the first interaction element to input and apply the noise cancellation configuration for the first type of noise corresponding to the first interaction element, or individually operate the second interaction element to input and apply the noise cancellation configuration for the second type of noise corresponding to the second interaction element, or sequentially operate both interaction elements to input and apply the noise cancellation configurations for the first and second types of noise.

At 405, in response to the target configuration parameter, the original data of the audio data is restored, the target configuration parameter is applied to the original data, and feedback audio data is output for feedback on the operation of the at least one interaction element.

Restoring the original audio data can be directly obtaining the original audio data or restoring the original audio data based on processed audio data and corresponding processing parameters. Then, the target configuration parameters can be directly applied to the original data to obtain and output feedback audio data corresponding to the target configuration parameters. This allows the user to perceive the audio effect of the feedback audio data obtained based on the configured target configuration parameters and determine whether the audio effect meets the user's expected processing effect.

The present disclosure describes the processing procedure for obtaining feedback audio data based on personalized noise cancellation configuration through user interaction, facilitating better understanding and implementation of the technical solution of the present disclosure by those skilled in the art.

In some embodiments, the audio data is obtained after processing by a target noise cancellation model, which has an original noise cancellation configuration and matches the scene in which the audio data is acquired. Based on this, the audio processing method may further include determining a target noise cancellation model corresponding to the audio data based on the audio data.

That is, multiple noise cancellation models are pre-configured in an electronic device, and different noise cancellation models are used to match different audio acquisition scenes. After the audio data is obtained, the target noise cancellation model can be selected from a set of pre-configured noise cancellation models to match the scene best suited to the audio data by identifying and processing the audio data. The conditions for matching the target noise cancellation model can be, but are not limited to, the audio data itself, and can also include other auxiliary content, such as a user-input reference scene or other environmental data from the recording scene.

The target noise cancellation model is the determined noise cancellation model that best matches the scene from which the audio data was acquired. This, however, does not imply that the default original noise cancellation configuration is optimal noise cancellation configuration for processing the audio data. Therefore, after determining the target noise cancellation model, the user can still input target configuration parameters for different types of noise in the audio data based on the first interaction element and/or the second interaction element.

Thus, the audio processing method further includes: obtaining target configuration parameters. The target configuration parameters are generated based on the operation of at least one interaction element, and the at least one interaction element includes either the first interaction element or the second interaction element. Based on the target configuration parameters, the original noise cancellation configuration of the target noise cancellation model of the audio data is processed to obtained items that match the target configuration parameters, thereby obtaining a target noise cancellation configuration that represents the user's expectations, so that the target noise cancellation model responds based on the target noise cancellation configuration when the target noise cancellation model is called.

The target noise cancellation model contains multiple noise cancellation configuration items, and the target configuration parameters may only include configuration parameters for some of these items. After the target configuration parameters are obtained, items in the original noise cancellation configuration of the target noise cancellation model for the audio data matching the target configuration parameters can be obtained by processing according to the target configuration parameters. For configuration items not involved in the target configuration parameters, the original configuration of the target noise cancellation model can be retained. For example, if the target noise cancellation model contains five noise cancellation configuration items (A, B, C, D, E), and the user-input target configuration parameters include A′, B′, and C′, involving three configuration items A, B, and C, then A′, B′, and C′ will replace A, B, and C, while D and E are retained. The final target noise cancellation configuration is A′, B′, C′, D, and E.

After the target noise cancellation configuration is obtained, the corresponding noise cancellation configuration can be saved in the target noise cancellation model. This way, if other audio data with the same acquisition scene as the audio data appears later, the target noise cancellation configuration can be directly called or switched to, to output the other audio data, eliminating the need for the user to repeatedly configure noise cancellation for audio data in the same acquisition scene.

The audio processing method described in the present disclosure, when multiple noise cancellation models are pre-installed in the electronic device, can first determine the target noise cancellation model that best matches the audio data acquisition scene. Then, based on the target configuration parameters input by the user through an interaction element, adjust the original noise cancellation configuration of the target noise cancellation model, so that the feedback audio data obtained by processing the adjusted target noise cancellation model can better meet matching user expectations.

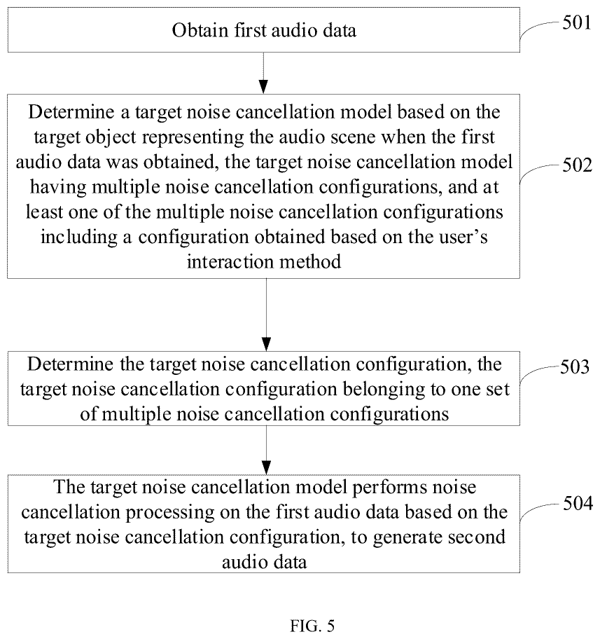

FIG. 5 is a flowchart of another audio processing method consistent with the present disclosure. The audio processing method FIG. 5 includes the following.

At 501, first audio data is obtained.

The first audio data can be audio data from video content or standalone audio data. The audio data can be audio data already exists or is stored in the electronic device, which may have already undergone noise cancellation processing by a corresponding noise cancellation model during the acquisition process.

At 502, a target noise cancellation model is determined based on the target object representing the audio scene when the first audio data was obtained. The target noise cancellation model has multiple noise cancellation configurations, and at least one of the multiple noise cancellation configurations includes a configuration obtained based on the user's interaction method.

The target object can be the audio data itself, or can include data other than the audio data, such as images, air pressure, ambient light, and geographical location. The data, other than the audio data, can be obtained from the video file corresponding to the audio data, such as, recording scene can be identified from an image, or the data can be automatically obtained by the electronic device through corresponding functions when acquiring audio/image data. For example, during recording, the electronic device can automatically detect address location, air pressure, etc., through a positioning device, or detect ambient light through a photosensitive element.

Based on the target object and the pre-trained recognition model, the target noise cancellation model that best matches the audio acquisition scene can be determined from the noise cancellation models pre-configured by the electronic device. Consistent with the present disclosure, the target noise cancellation model has been configured by the user at least once and the relevant noise cancellation configuration has been stored. Therefore, the target noise cancellation model includes multiple sets of noise cancellation configurations, of which at least one set is obtained based on the interaction method provided to the user. The interaction method includes the interaction elements described in the above embodiment.

At 503, the target noise cancellation configuration is determined, the target noise cancellation configuration belonging to one set of multiple noise cancellation configurations.

The target noise cancellation configuration is determined from the target noise cancellation model in different ways. For example, the target noise cancellation configuration can be determined based on the priority of each set of noise cancellation configurations or based on the user's choices. For instance, in the case of the target noise cancellation configuration can be determined based on the priority, if the configuration obtained through the user's interaction method has the highest priority among the multiple sets of noise cancellation configurations, then the noise cancellation configuration input by the user will be directly determined as the target noise cancellation configuration. In the case of the target noise cancellation configuration can be determined based on user choices, the target noise cancellation model will first output all noise cancellation configurations, and the user then selects the desired noise cancellation configuration as the target noise cancellation configuration.

The target noise cancellation configuration can be the original noise cancellation configuration of the target noise cancellation model, or the noise cancellation configuration previously input and saved by the user through interaction. Consistent with the present disclosure, the multiple sets of noise cancellation configurations in the target noise cancellation model can be switched to meet different user noise cancellation needs.

At 504, noise cancellation processing is performed by the target noise cancellation model on the first audio data based on the target noise cancellation configuration, to generate second audio data.

After the target noise cancellation configuration is determined, the target noise cancellation model performs noise cancellation processing on the first audio data according to the determined target noise cancellation configuration to obtain the second audio data.

Consistent with the present disclosure, the audio processing method, given that the target noise cancellation model has already been configured, can switch between different noise cancellation configurations based on established logic, and determines the target noise cancellation configuration from multiple sets of noise cancellation configurations according to the established logic to perform noise cancellation processing on the first audio data. The embodiment of the present disclosure provides users with more noise cancellation options and can meet different noise cancellation needs of users in different audio acquisition scenes.

In some embodiments, obtaining a target object of the audio data scene based on representation may include: capturing a target image using an image acquisition device, in which, the image acquisition device captures the target image during the acquisition of audio data, and the target object is the target image; and determining a target noise cancelation model based on the target image.

During video recording, electronic devices simultaneously acquire audio data and image data. The image data includes the target image. Based on the recognition processing of the target image, the audio data scene of the first audio data can be determined. For example, if the target image is determined as containing a stage through identification and analysis, and the stage includes people (performers) and various musical instruments, then the audio data scene of the first audio data can be determined to be a concert scene, and the noise cancelation model corresponding to the concert scene can be determined as the target noise cancelation model.

The above describes the embodiments of determining the target noise cancelation model based on the processing of the target image synchronized with audio data, facilitating a better understanding and implementation of the technical solution of the present disclosure by those skilled in the art.

For the sake of simplicity, the aforementioned method embodiments are all described as a series of actions. However, those skilled in the art should understand that the present disclosure is not limited to the described order of actions, because according to the present disclosure, some actions can be performed in other orders or simultaneously. Furthermore, those skilled in the art should also understand that the embodiments described in the specification are all preferred embodiments, and the actions and modules involved are not necessarily essential to the present disclosure.

The method is described in detail in the above embodiments of the present disclosure. The methods of the present disclosure can be implemented using various forms of devices. Therefore, a device is also provided in the present disclosure, and specific embodiments are described in detail below.

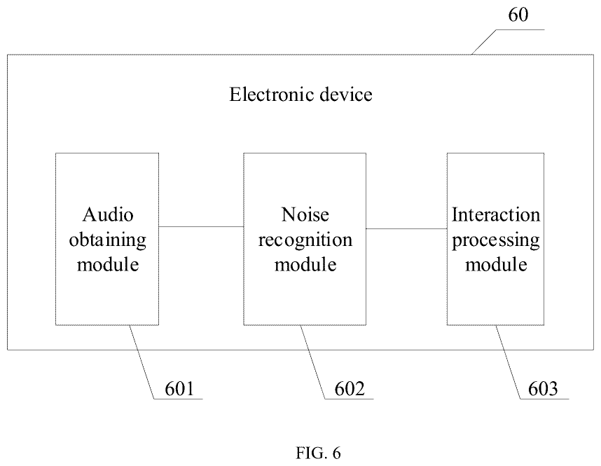

FIG. 6 is a schematic structural diagram of an electronic device consistent with the present disclosure. The electronic device 60 in FIG. 6 includes the following.

An audio obtaining module 601, configured to obtain audio data.

A noise recognition module 602, configured to identify at least two types of noise contained in the audio data based on the target model. The at least two types of noise include first type of noise and second type of noise, and the first type of noise and the second type of noise are of different types.

An interaction processing module 603, configured to output first interaction element corresponding to the first type of noise and second interaction element corresponding to the second type of noise. The first interaction element is used to configure noise cancellation for the first type of noise; the second interaction element is used to configure noise cancellation for the second type of noise.

The electronic device consistent with the present disclosure first identifies at least two types of noise in the audio data when performing noise cancellation processing, then outputs a corresponding interaction element for each type of noise, allowing the user to independently configure noise cancellation for each type of noise through the interaction element, thus meeting the user's need for personalized noise cancellation processing of audio data.

In some embodiments, the first interaction element is used to configure the noise cancellation for the first type of noise, including: the degree of noise cancellation processing for the first type of noise; the second interaction element is used to configure the noise cancellation for the second type of noise, including: the degree of noise cancellation processing for the second type of noise.

In some embodiments, the device further includes: a parameter obtaining module, configured to obtain target configuration parameters, in which the target configuration parameters are generated based on the operation of at least one interaction element, the at least one interaction element including any one of the following: the first interaction element; or, the second interaction element; and a noise cancellation control module, configured to respond to the target configuration parameters, restore the original data of the audio data, apply the target configuration parameters to the original data, and output feedback audio data for feedback on the operation of the at least one interaction element.

In some embodiments, the audio data is obtained after processing by the target noise cancellation model, the target noise cancellation model contains original noise cancellation configuration, and the target noise cancellation model matches the scene in which the audio data is acquired; the device may further include: a model determination module, configured to determine the target noise cancellation model corresponding to the audio data based on the audio data.

In some embodiments, the device may further include: a parameter obtaining module, configured to obtain target configuration parameters, in which the target configuration parameters are generated based on the operation of at least one interaction element, the at least one interaction element including any one of the following: first interaction element; or, second interaction element; and a noise cancellation control module, configured to process and obtain items in the original noise cancellation configuration of the target noise cancellation model for the audio data matching the target configuration parameters according to the target configuration parameters, and obtain a target noise cancellation configuration characterizing the user's expectations, so that the target noise cancellation model responds based on the target noise cancellation configuration when invoked.

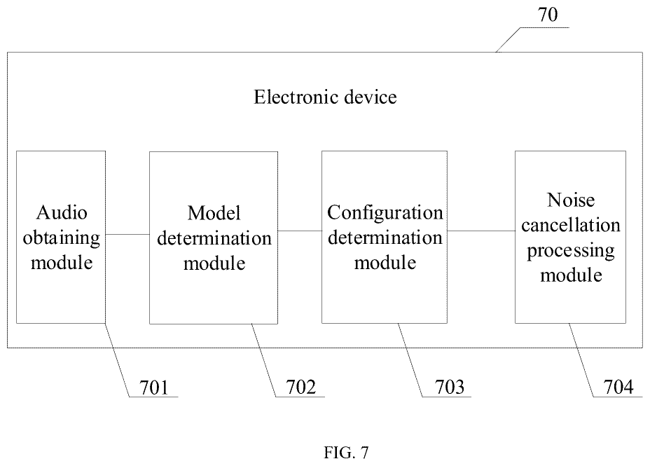

FIG. 7 is a schematic structure diagram of another electronic device consistent with the present disclosure. Referring to FIG. 7, the electronic device 70 includes the following.

An audio obtaining module 701, configured to obtain first audio data.

A model determination module 702, configured to determine a target noise cancellation model based on a target object representing the audio scene at the time the first audio data is acquired. The target noise cancellation model contains multiple sets of noise cancellation configurations, and the multiple noise cancellation configurations include at least one set of noise cancellation configuration obtained based on an interaction method provided to the user.

A configuration determination module 703, configured to determine a target noise cancellation configuration, which belongs to one set of multiple noise cancellation configurations.

A noise cancellation processing module 704, configured to control the target noise cancellation model to perform noise cancellation processing on the first audio data based on the target noise cancellation configuration and generate second audio data.

Consistent with the present disclosure, when the target noise cancellation model has already been configured, the electronic device can switch between different noise cancellation configurations based on established logic, and determines the target noise cancellation configuration from multiple sets of noise cancellation configurations to perform noise cancellation processing on the first audio data according to the established logic. The present disclosure provides users with more noise cancellation options and can meet the different noise cancellation needs of users in different audio acquisition scenes.

In some embodiments, the model determination module is used for capturing a target image based on an image acquisition device, in which the image acquisition device captures the target image during the acquisition of audio data, and the target object is the target image; and determining a target noise cancellation model based on the target image.

In some embodiments, the configuration obtained based on the interaction method provided to the user has the highest priority among the multiple sets of noise cancellation configurations.

The specific implementations of the above-mentioned electronic device and its various modules, as well as other possible implementations, can be found in the corresponding sections of the method embodiments.

The electronic device described in any of the above embodiments includes processor and memory. The audio obtaining module, noise recognition module, interaction processing module, model determination module, configuration determination module, and noise cancellation processing module described in the above embodiments can all be stored as program modules in the memory. The processor executes these program modules stored in the memory to implement their corresponding functions.

The processor contains kernel, which retrieves the corresponding program modules from the memory. One or more kernels can be configured, and the processing of revisited data can be achieved by adjusting kernel parameters.

The memory may include non-permanent memory in computer-readable media, such as random access memory (RAM) and/or non-volatile memory, such as read-only memory (ROM) or flash RAM. The memory includes at least one storage chip.

In some embodiments, a computer-readable storage medium is also provided, which can be directly loaded into the computer's internal memory. The computer-readable storage medium contains software code, and the computer software code, after being loaded and executed by the computer, can implement the methods shown in any embodiment of the audio processing method described above.

In some embodiments, a computer program product is also provided, which can be directly loaded into the computer's internal memory. The computer program contains software code, and the computer program, after being loaded and executed by the computer, can implement the methods shown in any embodiment of the audio processing method described above.

The various embodiments consistent with the present disclosure are presented in a progressive manner, with each embodiment focusing on its differences from other embodiments. For descriptions of similar or identical parts between embodiments, reference can be made to each other.

It should also be noted that, in this document, relational terms such as “first” and “second” are used only to distinguish one entity or operation from another, and do not necessarily require or imply any such actual relationship or order between these entities or operations. Furthermore, the terms “comprising,” “including,” or any other variations thereof are intended to cover non-exclusive inclusion, such that a process, method, article, or device that comprises a list of elements includes not only those elements, but also other elements not expressly listed, or elements inherent to such a process, method, article, or device. Without further limitations, an element associated with the phrase “comprising . . . ” does not exclude the presence of other identical elements in the process, method, article, or device that includes said element.

The methods or algorithms consistent with the embodiments of the present disclosure can be implemented directly by hardware, software modules executed by a processor, or a combination of both. Software modules can be stored in random access memory (RAM), memory, read-only memory (ROM), electrically programmable ROM, electrically erasable programmable ROM, registers, hard disks, removable disks, CD-ROMs, or any other form of storage medium known in the art.

The above description of the disclosed embodiments enables those skilled in the art to make or use the implementation. Various modifications to these embodiments will be readily apparent to those skilled in the art, and the general principles described herein may be implemented in other embodiments without departing from the spirit or scope of the present disclosure. Therefore, the embodiments are not to be limited to the present disclosure but is to be accorded the widest scope consistent with the principles and features disclosed herein.

What is claimed is:

1. A method of audio processing comprising:
obtaining audio data;
identifying, based on a target model, a first type of noise and a second type of noise from the audio data, the first type of noise and the second type of noise being of different types; and
outputting a first interaction element corresponding to the first type of noise and a second interaction element corresponding to the second type of noise, the first interaction element being configured to configure noise cancellation for the first type of noise, and the second interaction element being configured to configure noise cancellation for the second type of noise.

2. The method according to claim 1, wherein:
the first interaction element is configured to configure a degree of noise cancellation processing for the first type of noise; and
the second interaction element is configured to configure a degree of noise cancellation processing for the second type of noise.

3. The method according to claim 1, further comprising:
obtaining a target configuration parameter generated based on an operation of at least one of the first interaction element or the second interaction element; and
in response to the target configuration parameter, restoring original data of the audio data, and applying the target configuration parameter on the original data to output feedback audio data for feedback on the operation.

4. The method according to claim 1, further comprising:
determining a target noise cancellation model corresponding to the audio data, the target noise cancellation model having an original noise cancellation configuration and matching a scene in which the audio data is acquired; and
performing processing using the target noise cancellation model to obtain the audio data.

5. The method according to claim 4, further comprising:
obtaining a target configuration parameter generated based on an operation of at least one of the first interaction element or the second interaction element; and
performing adjustment processing based on the target configuration parameter to obtain one or more items in the original noise cancellation configuration that match the target configuration parameters, to obtain a target noise cancellation configuration characterizing a user expectation, to enable the target noise cancellation model to respond based on the target noise cancellation configuration when invoked.

6. A non-transitory computer-readable storage medium storing instructions that, when executed by a processor, cause an electronic device including the processor to perform the method according to claim 1.

7. The storage medium according to claim 6, wherein:
the first interaction element is configured to configure a degree of noise cancellation processing for the first type of noise; and
the second interaction element is configured to configure a degree of noise cancellation processing for the second type of noise.

8. The storage medium according to claim 6, wherein the instructions, when executed by the processor, further cause the electronic device to:
obtain a target configuration parameter generated based on an operation of at least one of the first interaction element or the second interaction element; and
in response to the target configuration parameter, restore original data of the audio data, and apply the target configuration parameter on the original data to output feedback audio data for feedback on the operation.

9. An electronic device comprising:
a processor; and
a memory storing instructions that, when executed by the processor, cause the electronic device to:
obtain audio data;
identify, based on a target model, a first type of noise and a second type of noise from the audio data, the first type of noise and the second type of noise being of different types; and
output a first interaction element corresponding to the first type of noise and a second interaction element corresponding to the second type of noise, the first interaction element being configured to configure noise cancellation for the first type of noise, and
the second interaction element being configured to configure noise cancellation for the second type of noise.

10. The electronic device according to claim 9, wherein:
the first interaction element is configured to configure a degree of noise cancellation processing for the first type of noise; and
the second interaction element is configured to configure a degree of noise cancellation processing for the second type of noise.

11. The electronic device according to claim 9, wherein the instructions, when executed by the processor, further cause the electronic device to:
obtain a target configuration parameter generated based on an operation of at least one of the first interaction element or the second interaction element; and
in response to the target configuration parameter, restore original data of the audio data, and apply the target configuration parameter on the original data to output feedback audio data for feedback on the operation.

12. The electronic device according to claim 9, wherein the instructions, when executed by the processor, further cause the electronic device to:
determine a target noise cancellation model corresponding to the audio data, the target noise cancellation model having an original noise cancellation configuration and matching a scene in which the audio data is acquired; and
perform processing using the target noise cancellation model to obtain the audio data.

13. The electronic device according to claim 12, wherein the instructions, when executed by the processor, further cause the electronic device to:
obtain a target configuration parameter generated based on an operation of at least one of the first interaction element or the second interaction element; and
perform adjustment processing based on the target configuration parameter to obtain one or more items in the original noise cancellation configuration that match the target configuration parameters, to obtain a target noise cancellation configuration characterizing a user expectation, to enable the target noise cancellation model to respond based on the target noise cancellation configuration when invoked.

14. A method of audio processing comprising:
obtaining first audio data;
determining a target noise cancellation model based on a target object representing an audio scene in which the first audio data is obtained, the target noise cancellation model having a plurality of sets of noise cancellation configurations, and the plurality of sets of noise cancellation configurations including at least one set of configurations obtained based on an interaction method provided to the user;
determining a target noise cancellation configuration, the target noise cancellation configuration belonging to one set of the plurality of sets of noise cancellation configurations; and
performing, using the target noise cancellation model, noise cancellation processing on the first audio data based on the target noise cancellation configuration to generate second audio data.

15. The method according to claim 14, wherein obtaining the target noise cancellation model includes:
capturing a target image as the target object based on an image acquisition device in a process of the image acquisition device obtaining audio data; and
determining the target noise cancellation model based on the target image.

16. The method according to claim 14, wherein the at least one set of configurations has a highest priority among the plurality of sets of noise cancellation configurations.

17. An electronic device comprising:
a processor; and
a memory storing instructions that, when executed by the processor, cause the electronic device to perform a method of claim 14.

18. The electronic device according to claim 17, wherein the instructions, when executed by the processor, further cause the electronic device to:
capture a target image as the target object based on an image acquisition device in a process of the image acquisition device obtaining audio data; and
determine the target noise cancellation model based on the target image.

19. The electronic device according to claim 17, wherein the at least one set of configurations has a highest priority among the plurality of sets of noise cancellation configurations.

20. A non-transitory computer-readable storage medium storing instructions that, when executed by a processor, cause an electronic device including the processor to perform the method according to claim 14.
